(19) United States
(12) Patent Application Publication
(10) Pub. No.: US 2006/0033629 A1
(43) Pub. Date: Feb. 16, 2006

(54) Over flow sensor

(75) Inventors: Craig J. Froeter, Sterling, IL (US); Jeff Giordano, Moline, IL (US)

Correspondence Address: REINHART BOERNER VAN DEUREN LTD., 483 NORTH MULFORD ROAD, SUITE 7, ROCKFORD, IL, 61107, US

(73) Assignee: Froet Industries, LLC, Sterling, IL (US)

(21) Appl. No.: 11/202,765

(22) Filed: Aug. 12, 2005

Related U.S. Application Data
(60) Provisional application No. 60/601,542, filed on Aug. 13, 2004.

(51) Int. Cl. G08B 21/00

(52) U.S. Cl. 340/603

(57) ABSTRACT

An overflow sensor adapted to detect water flow in a backup roof drainage system is provided. The overflow sensor comprises a housing, a water flow sensor, and a control module. The housing is configured to sealingly mate with the backup roof drainage system. The water flow sensor is coupled to the housing and positioned to detect a flow of water of at least two levels in the backup drainage system. The control module is in communication with the water flow sensor and includes an indicator activatable when the water flow sensor detects the flow of water in the backup roof drainage system. This indicator is latched on until reset.

### CROSS-REFERENCE TO RELATED PATENT APPLICATIONS

This patent application claims the benefit of U.S. Provisional Patent Application No. 60/601,542, filed Aug. 10, 2004, the teachings and disclosure of which are hereby incorporated in their entireties by reference thereto.

### FIELD OF THE INVENTION

This invention relates generally to a roof drainage system and, more particularly, to a water flow sensor for monitoring the flow of water in a backup roof drainage system.

### BACKGROUND OF THE INVENTION

Commercial and industrial buildings are typically constructed with flat or near flat roofs. Because these buildings do not have much if any of a pitch to the roof the collection of water on the roof surface resulting from rain and melting snow could present a serious structural load that could result in collapse of the roofs structure. To avoid this possibility most commercial and industrial building standards require that roofs of this type include drains positioned at locations that ensure that at least the majority of water accumulation may be removed from the roof through a drainage plumbing system.

Typical roof drains are installed on flat roofs by cutting a hole through the roof deck and installing a drain there through. The drain typically connects with drainage plumbing that carries the water away. The drain structure typically includes some form of flashing or collar that, through the application of sealant or other roof material prevents leakage at the site of the drain installation. These typical drain structures also include some form of drain ring and under deck clamping ring or structure that holds the drain in place and prevents its inadvertent removal or dislodgement from its installed position. The opening of the roof drain is typically covered by some form of grating or strainer structure to prevent the ingestion of large objects into the drain plumbing system. In most roof drain structures this strainer or grate takes the form of a hemispherical strainer to prevent or minimize the occurrence of obstruction of the roof drain through the accumulation of leaves and other debris that may accumulate on the roof.

Despite the inclusion of a strainer or other grating structure, many roof drains still become plugged or otherwise obstructed to the point that inhibits their ability to remove the accumulated water from the roof of the building. These obstructions can occur as a result of the collection of debris around or over the grate or strainer structure. Additionally, obstructions may also result in the roof drain system during winter months as a result of icing near the roof level of the open areas of the strainer. In addition to the obvious problems resulting from complete obstruction of the roof drains, minor obstructions that merely result in the reduction in the rate of water removal from the roof may also result in undo stress on the roof structure that may endanger its integrity. Additionally, even unobstructed roof drains may not be able to remove water at a rate to prevent its undue accumulation during periods of heavy storms and intense rainfall.

In recognition of the limitations of a single roof drain system, many building codes and many more contractors are installing backup roof drains connected to a separate drainage system to ensure that the load carrying capacity of a roof structure is not exceeded if the primary roof drain system fails to remove the water accumulation at a sufficient rate. These backup roof drains are typically constructed in the same manner as the primary roof drains, but include a structure that prohibits the drainage of water through the backup roof drainage system until the level of the water reaches a predetermined depth. That is, the entry ports or slots on the backup roof drains are positioned at a height above the roof surface. This height is preferably chosen based upon the roof construction such that the weight of the water at that given height is well within the load carrying of the roof structure. The separate drainage system ensures that failure of the primary roof drain system due to an obstruction in the drainage system downstream from the roof drains will not effect the ability of the backup roof drain system to remove the water that accumulates above a given depth.

While roof drain systems with primary and backup roof drains ensure that water is collected and carried away from a roof, such dual roof drain systems do not indicate to a building owner (or tenant) which of the two drains is performing the water dissipation function. In those situations where the primary roof drain is plugged or malfunctioning and the backup drain is operating to relieve the roof of water, any redundancy afforded by the dual roof drain system is lost. Moreover, since the backup drain opening is higher than the primary drain opening, water is allowed to accumulate on the roof to the level of the backup drain level, increasing stress on the building. Since there is no way for the building owner or tenet to know that this situation is occurring, the building owner or tenet does not know, nor can he even suspect, that measures need to be taken to unplug or fix the primary drain.

Therefore, a system capable of notifying a building owner or tenant that a backup drain has been called upon and/or that the primary system has been ineffective would be desirable. The invention provides such a notification apparatus and system. These and other advantages of the invention, as well as additional inventive features, will be apparent from the description of the invention provided herein.

### BRIEF SUMMARY OF THE INVENTION

In one aspect, the invention provides an overflow sensor adapted to detect water in a backup roof drainage system. The overflow sensor comprises a housing, a water flow sensor, and a control module. The housing is configured to sealingly mate with the backup roof drainage system. The water flow sensor is coupled to the housing to detect a flow of water therethrough. The control module is in communication with the water flow sensor and provides an indication when the water flow sensor detects the flow of water through the housing.

In another aspect, the invention provides a roof drain monitoring system that comprises a primary a primary roof drain coupled to a primary roof drainage system, a backup roof drain coupled to a backup roof drainage system, and an overflow sensor coupled to the backup roof drainage system to detect a flow of water in the backup roof drainage system.

In yet another aspect, the invention provides a method of detecting a malfunction in at least one of a primary drain and a primary roof drainage system where the primary drain and the primary roof drainage system are supported by a backup drain pipe coupled to a backup roof drainage system. To begin, the backup roof drainage system is monitored for a flow of water. Then, an alarm signal is generated when the flow of water in the backup roof drainage system is sensed.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic of an embodiment of an overflow sensor constructed in accordance with the teachings of the present invention;

FIG. 2 is a side elevation view of a housing from the overflow sensor of FIG. 1 when the housing is coupled to a portion of a backup roof drainage system;

FIG. 3 is simplified schematic of the overflow sensor of FIG. 1 coupled to a portion of the backup roof drainage system in a building; and

FIG. 4 is simplified schematic of the overflow sensor of FIG. 1 coupled to a portion of the backup roof drainage system in a building employing a bi-functional roof drain.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

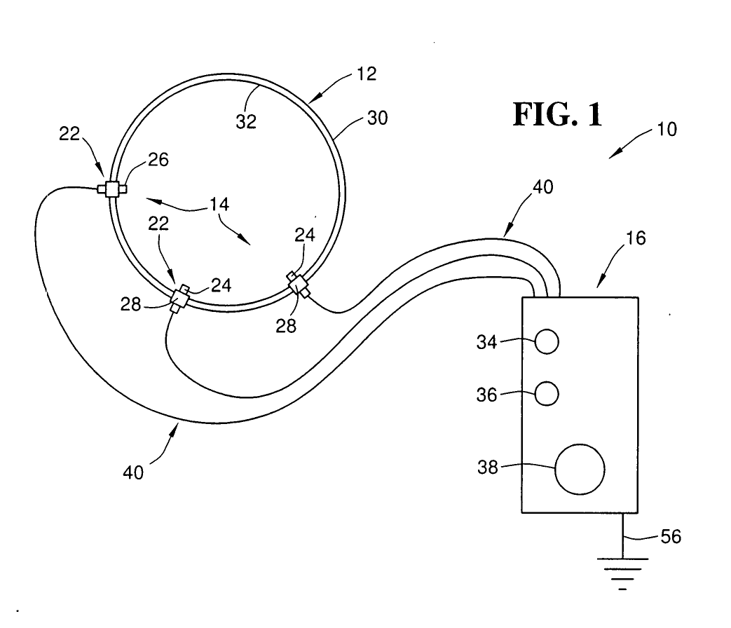

Referring to FIG. 1, an embodiment of an overflow sensor 10 constructed in accordance with the teachings of the present invention is illustrated. As will be more fully explained below, the overflow sensor 10 advantageously monitors a portion of the backup roof drainage system and immediately notifies a building owner (or tenant) if the backup roof drainage system is called upon to convey water from a building's roof. Preferably, the monitor is installed in a horizontal portion of the backup drainage system, although the sensor 10 of the present invention may be effective in angled sections as well.

Once the sensor 10 detects water flow in the backup drain system, notification effectively advises the building owner that it is likely that the primary drain and/or the primary roof drainage system has malfunctioned (e.g., when the primary roof drainage system is plugged by debris). Having been appropriately alerted, the building owner can take the necessary steps to remedy the problem or problems with the primary drain and/or drainage system thereby restoring the redundancy provided by two independent drains and drain systems. Preferably, once the system 10 detects the flow of water in the backup drainage system, the notification is latched on to increase the likelihood that the owner will receive the notification.

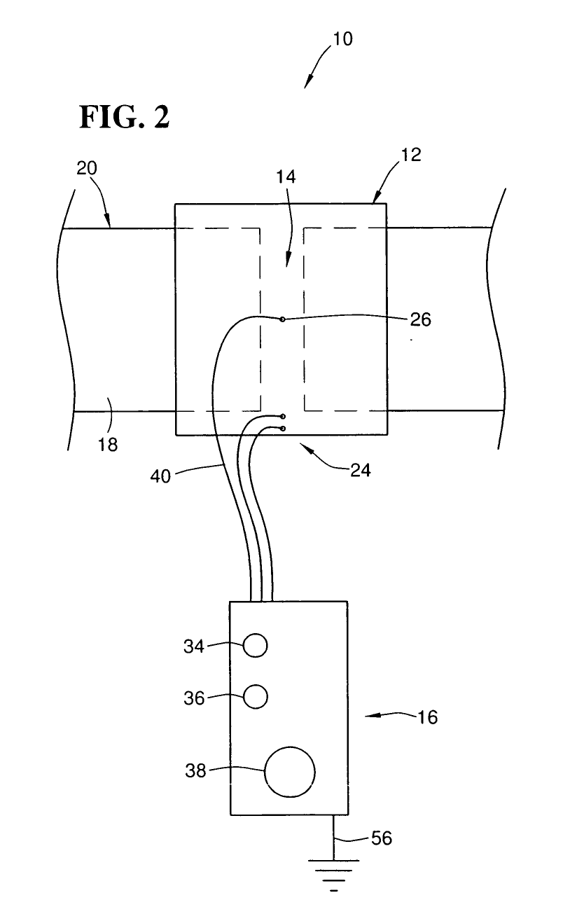

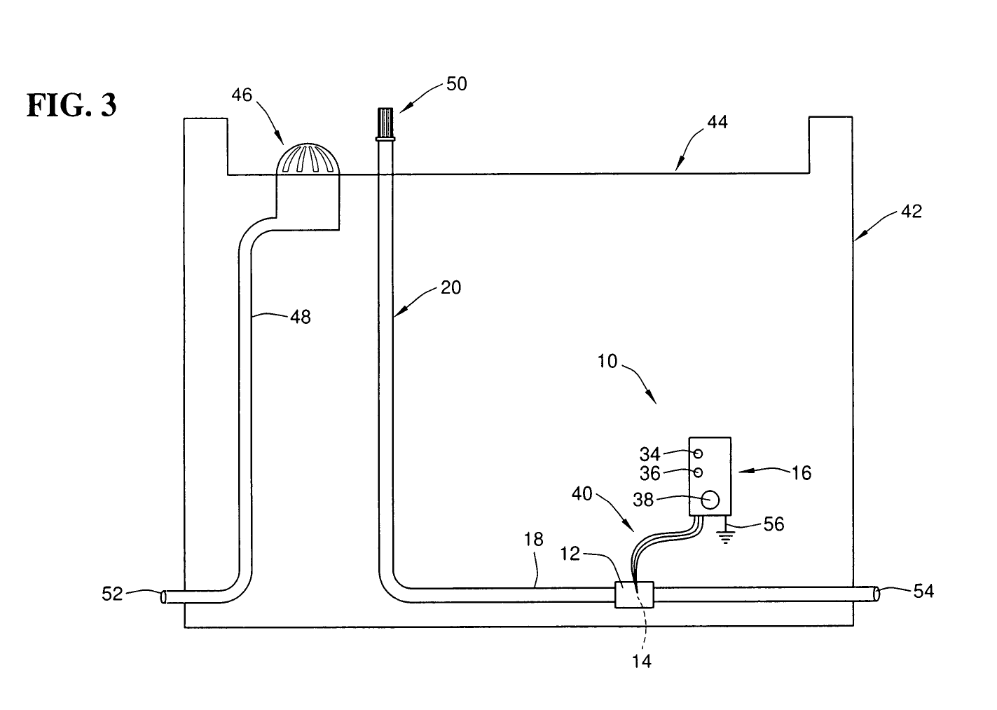

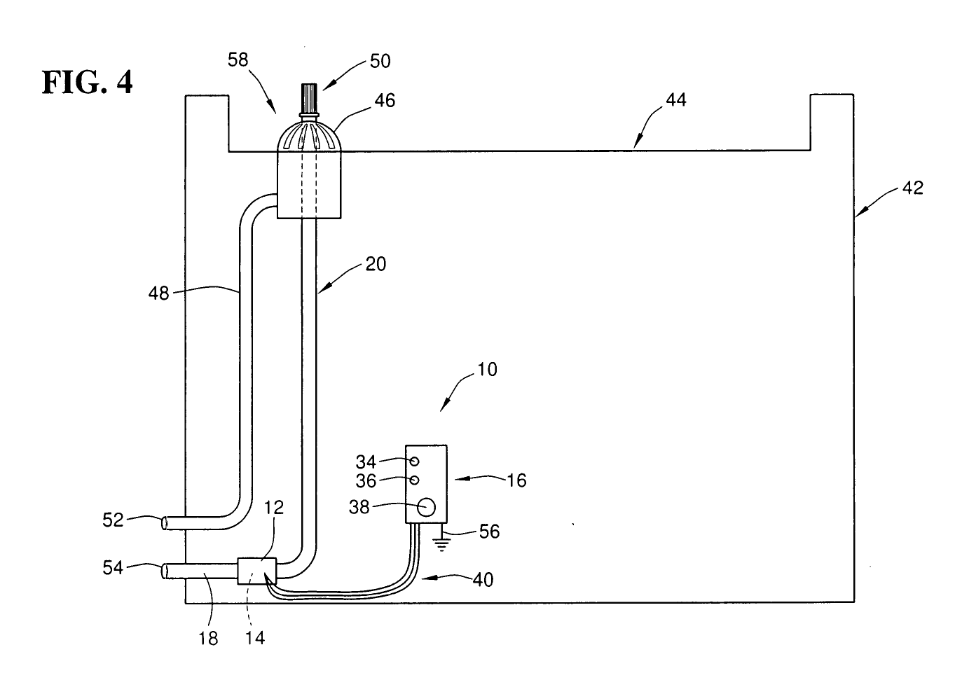

As shown in FIG. 1, the overflow sensor 10 comprises a housing 12, a water flow sensor 14, and a control module 16. The housing 12 is typically constructed of a water impervious material such as, for example, polyvinyl chloride (PVC), steel, cast iron, copper, and the like. In the illustrated embodiment and as shown in FIG. 2, the housing 12 is adapted and dimensioned to sealingly couple with a portion 18 of a backup roof drainage system 20 (see, e.g., FIGS. 3 and 4). The portion 18 of the backup roof drainage system 20 is, like the housing 12, also constructed of a water impervious material such as, for example, polyvinyl chloride (PVC), steel, cast iron, copper, and the like.

Despite the circular cross section of the housing 12 in the illustrated embodiment of FIG. 1, the housing can easily have or take a variety of different shapes to correspond to the shape and dimensions of the portion 18 of the backup roof drainage system 20. The housing 12 can include one or more apertures 22, as shown in FIG. 1, as well as other mechanisms and/or devices to support and accommodate the water flow sensor 14 that is associated therewith.

The water flow sensor 14 is coupled to or simply proximate the housing 12 and, as such, can sense or detect the presence of water and/or a flow of water in the housing 12. In the illustrated embodiment, the water flow sensor 14 is depicted as a pair of contacts 24 (one positive and one negative) and a single contact 26 (either a positive or a negative electrically paired with the opposite polarity contact of pair 24) that sealingly penetrate the housing 12 using the apertures 22. The single contact 26 is generally in spaced relation with the pair of contacts 24. Preferably, the single contact 26 is positioned vertically above the pair of contacts 24. In this arrangement, and since the housing is preferably coupled to a horizontal portion 18 of the backup roof drainage system 20, one of the pair of contacts 24 is referred to as the “minimum flow” contact and the single contact 26 is referred to as the “high flow” contact.

When the single contact 26 and the pair of contacts 24 sealingly penetrate the housing 12 as shown in FIG. 1, the contacts 24, 26 can be inserted through the apertures 22 and sealed in the housing 12 using a variety of devices and/or methods known to those skilled in the art such as, for example, with epoxy, plumbing tape, mating threads, and the like. Furthermore, in embodiments wherein the housing 12 is formed from a electrically conducting material, insulators 28 are employed to isolate the contacts from the housing.

The water flow sensor 14 is not limited to being formed from individual and/or pairs of contacts 24, 26. The water flow sensor 14 can be any electrical and/or mechanical sensor capable of detecting the presence and/or a flow of water. Moreover, the water flow sensor 14 is not required to penetrate the housing 12 and can be affixed to the outside surface 30 of the housing 12, secured to the inside surface 32 of the housing, and/or simply be located proximate the housing. Such sensor types and configurations contemplate the use of flow meters, flog loggers, velocimeters, laser-based interferometry, Doppler-based methods of flow measurement, hall effect sensors, and the like, as well known to those skilled in the art.

Still referring to FIG. 1, the control module 16 includes a first indictor 34, a second indicator 36, and a reset mechanism 38. The control module 16 is operatively in communication with the water flow sensor 14. In the illustrated embodiment, such communication is performed by leads or wires 40 that couple the control module 16 and the contacts 24, 26. However, other types of communication between the control module 16 and the water flow sensor 14 can be employed. For example, the control module 16 and the water flow sensor 14 can communicate wirelessly with the addition of appropriate transmitter and receiver circuitry.

Whether by wires 40 or otherwise, the first indicator 34 is operably coupled with the pair of contacts 24 to indicate that the backup system is or has experienced a low flow of water therethrough, and the second indictor 36 is operably coupled with the single contact 26 and one of the pair of contacts 24 of the opposite polarity (e.g., the ground contact of the pair 24 in an embodiment where contact 26 is a positive contact). In a preferred embodiment, the first indicator 34 on the control module 16 is a yellow light emitting diode (LED) or light and the second indicator 36 on the control module is a red LED or light. In such an embodiment, when water in or passing through the housing 12 is detected by the pair of contacts 24, the yellow LED indicator 34 on the control module 16 illuminates. If the water rises high enough in the housing 12 to be detected by the contact 26, the red LED illuminates. In one embodiment, only a single indicator 34, 36 is illuminated, with the indicator 36 having priority over indicator 34. To provide additional visibility, either or both of the indicators may be flashed or strobed, etc. If desired, an audible alarm signal can be sounded at or around the same time that the one or both of the indicators 34, 36 are triggered to provide both a visual and audible alarm signal.

In one embodiment, the water flow sensor 14 is adapted to report data pertaining to the water and/or water flow rate to the control module 16 and, in turn, the control module is adapted to relay that reported data, along with an alarm signal, to one of a computer, a data logger, a programmable logic device, etc. This information can be stored, used for later comparisons, analyzed, and the like.

In a preferred embodiment, each of the indicators 34, 36 found on the control module 16 is latched “on” once that particular indicator has been activated, triggered and/or illuminated. Alternatively, the indicator 36 would operate to turn off indicator 34 so that only a single indication of the maximum flow is provided. In either embodiment, one or both of the indicators 34, 36 will stay illuminated, flashing, beeping, and the like, until the building owner (or tenant) takes some affirmative action to turn the indicator off. In one embodiment, this task can be accomplished by a building owner actuating the reset mechanism 38 on the control module 16. In the illustrated embodiment, since the reset mechanism 38 is a button, the owner simply depresses that button to deactivate the indicators 34, 36. By requiring that the reset mechanism 38 be manipulated and/or actuated in order to turn off the indicators 34, 36, it can be guaranteed that the building owner will be notified any time water is detected inside or flowing through the housing.

Turning to FIG. 3, the overflow sensor 10 is shown as incorporated into a building 42 having a roof 44, a primary drain 46 coupled to a primary roof drainage system 48, and a backup drain 50 coupled to a backup roof drainage system 20 having a generally horizontal portion 18. Each of the primary and backup roof drainage systems 48, 20 has an outlet 52, 54 removed from the building 42. Therefore, water that falls upon or finds its way to the roof 44 is able to be carried from the roof to a location away from (and not on top of) the building 42 by each of the drainage systems 48, 20. In a preferred embodiment, the primary and backup roof drainage systems 48, 20 provide entirely separate paths for the water to leave the roof 44. However, at least in some cases, the primary and secondary drainage systems 48, 20 are joined together before exiting the building 42 and, as such, share an outlet.

Since the roof 44 of the building 42 is generally flat, when it rains the primary drain 46 and the primary roof drainage system 48 are relied upon to remove and/or dissipate the water so it doesn't accumulate. If, for example, a collection of debris obstructs, clogs, and/or prohibits the normal operation of the primary roof drain 46 and drainage system 48, and water does begin to accumulate on the roof 42, the backup roof drain 50 and drainage system 20 will eventually be called upon to remove the water from the roof if the level of water rises enough. When this situation occurs, the system 10 of the present invention will indicate to the building owner that one or both of the primary roof drain and drainage system 46, 48 have malfunctioned and/or are clogged.

As illustrated in this FIG. 3, the housing 12 of the overflow sensor 10 is coupled to the generally horizontal portion 18 of the backup roof drainage system 20. Notably, in those situations where the primary and secondary drainage systems 48, 20 unite somewhere after (i.e., downstream of) the primary and secondary drains 46, 50, the housing 12 is coupled to a portion of the secondary drainage system somewhere before (i.e., upstream of) the convergence of the two systems, preferably in a generally horizontal portion.

Continuing, in the illustrated embodiment, the control module 16 provides a small voltage to one of the pairs of contacts 24 and to the single contact 26. The control module couples the other of the pair contacts 24 to a ground 56. When the primary roof drain and/or primary drainage system 46, 48 fails, and the backup roof drain and drainage system 50, 20 is called upon, water begins to flow through the housing 12 that has been coupled to the generally horizontal portion 18 of the backup roof drainage system. As the water flows through the housing 12 or while the water resides therein, the water is detected by the water flow sensor 14. In the illustrated embodiment, when the water flows in between the pair of contacts 24, the water completes an electrical circuit. Completion of the circuit causes, for example, the yellow LED indicator 34 to illuminate. Once illuminated, the indicator 34 is latched on and stays illuminated until the resent mechanism 38 is actuated.

If the water level in the housing 12 rises to a level where the single contact 26 is reached, again, an electrical circuit is formed. This additional electrical circuit causes, for example, the red LED indicator 36 to illuminate. Like before, once illuminated, the indicator is latched on and stays illuminated until the reset mechanism 38 is actuated. Therefore, even after the backup roof drain and drainage system 50, 20 no longer are draining any more water from the roof, one or both of the indicators 34, 36 remain on to warm and inform the building owner that there is a problem with the primary drain 46 and/or the primary roof drainage system 48.

Latching of the indicators 34, 36 is beneficial when, e.g., water flows through the housing 12 during the night when the building owner is not typically not monitoring the indicators 34, 36. If the indicators only remain illuminated during the time that water is actually flowing, the primary drain blockage situation may not be detected. This is because, as soon as the water stops flowing in the backup system, the indicators would no longer be illuminated. If the building owner fails to notice that one or both of the indicators were on during the brief period when water continued to flow, the building owner would not know that the backup roof drainage system 20 had been called upon. Nor would the building owner be informed that there is likely a problem with the primary drain and/or roof drainage system 46, 48.

If the building owner simply began monitoring the indicators 34, 36 the next morning during typical business hours, the building owner would be naïve to the previous nights drainage activity. In fact, if the indicators 34, 36 are not latched on, as in this example, the building owner would find no illuminated indicators on the control module in the morning and might be deceptively misled into believing that the primary roof drain and drainage system 46, 48 were operating properly. However, when the indicators 34, 36 are latched on, the building owner is appraised of the circumstances no matter how long it has been since the primary roof drain and/or drainage system 46, 48 were plugged and the backup roof drain and drainage system 50, 20 were relied upon as long as the reset mechanism 38 has not been manipulated.

As shown, in FIG. 4, the overflow sensor 10 is illustrated employed with a bi-directional roof drain 58. The bi-functional roof drain 58 combines both a primary drain 46 and a backup drain 50 in the same housing. Like before, the primary drain 46 is still coupled to the primary roof drainage system 48 and the backup drain 50 is still coupled to a backup roof drainage system 20 with a generally horizontal or angled portion.

Beneficially, the housing 12 of the overflow sensor 10 can be incorporated into a new backup roof drainage system or, if desired, retro fit into one that is previously existing. As such, the overflow sensor 10 is employable in new buildings as well as adaptable to older, existing buildings. Also, the control module 16 can be located in a central portion of the building 42. Additionally, multiple control modules 16 can be employed to monitor a plurality of backup roof drainage systems coupled to one or more backup roof drains.

All references, including publications, patent applications, and patents cited herein are hereby incorporated by reference to the same extent as if each reference were individually and specifically indicated to be incorporated by reference and were set forth in its entirely herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An overflow sensor adapted to detect water in a backup roof drainage system, the overflow sensor comprising:
a housing configured to sealingly mate with the backup roof drainage system;
a water flow sensor coupled to the housing to detect a flow of water therethrough; and
a control module in communication with the water flow sensor, the control module providing an indication when the water flow sensor detects the flow of water through the housing.

2. The overflow sensor of claim 1, wherein the water flow sensor is configured to sense at least two levels of water flow through the housing.

3. The overflow sensor of claim 1, wherein the housing is constructed of one of polyvinyl chloride (PVC), steel, cast iron, and copper.

4. The overflow sensor of claim 1, wherein the control module latches the indication so that the indication remains after the flow of water is no longer detected by the water flow sensor.

5. The overflow sensor of claim 1, wherein at least one of the water flow sensor sealingly penetrates the housing.

6. The overflow sensor of claim 1, wherein the water flow sensor comprises a pair of contacts positioned to sense the flow of water at a first level through the housing, and a single contact positioned to sense the flow of water at a second level through the housing.

7. The overflow sensor of claim 6, wherein one of the pair of contacts and the single contact are provided with a voltage and another of the pair of contacts is coupled to a ground.

8. The overflow sensor of claim 1, wherein the housing is constructed from an electrically conducting material, and wherein the overflow sensor further comprises an insulator disposed between the flow sensor and the housing.

9. The overflow sensor of claim 1, wherein the control module includes a reset mechanism for the indication.

10. The overflow sensor of claim 1, wherein the water flow sensor is configured to sense at least two levels of water flow through the housing, and wherein the control module provides a different indication for each of the at least two levels of water flow through the housing.

11. The overflow sensor of claim 10, wherein the control module prioritizes the different indications for each of the at least two levels of water flow through the housing so that the indication for a higher level of water flow has priority over the indication for a lower level of water flow.

12. A roof drain monitoring system comprising:
a primary roof drain coupled to a primary roof drainage system;
a backup roof drain coupled to a backup roof drainage system; and
an overflow sensor coupled to the backup roof drainage system to detect a flow of water in the backup roof drainage system.

13. The system of claim 12, wherein the overflow sensor comprises:
a housing;
a first water flow sensor coupled to the housing to detect a first flow of water therethrough; and
a control module in communication with the first water flow sensor, the control module providing an indication when the first water flow sensor detects the first flow of water through the housing.

14. The system of claim 13, wherein the overflow sensor comprises a second water flow sensor coupled to the housing and in spaced relation with the first water flow sensor, the second water flow sensor positioned to detect a second flow of water, the second flow of water greater than the first flow.

15. The system of claim 13, wherein the indicator generates at least one of an audible signal and visual signal when activated.

16. The system of claim 13, wherein the control module includes an indicator reset mechanism, the first indicator being latched when turned on until the indicator reset mechanism is actuated.

17. The system of claim 12, wherein overflow sensor provides a visual indication when the flow of water in the backup drainage system is detected.

18. A method of detecting a malfunction in at least one of a primary drain and a primary roof drainage system, the primary drain and the primary roof drainage system supported by a backup drain pipe coupled to a backup roof drainage system, the method comprising the steps of:
monitoring the backup roof drainage system for a flow of water; and
generating an alarm signal when the flow of water in the backup roof drainage system is sensed.

19. The method of claim 18, further comprising the step of latching the alarm signal.

20. The method of claim 18, further comprising the step of resetting the alarm signal.
